(19) United States
(12) Patent Application Publication
(10) Pub. No.: US 2026/0303381 A1
(43) Pub. Date: Oct. 1, 2026

(54) A SYSTEM FOR PARTIALLY SYNCHRONOUS SCALABLE BLOCKCHAINS

(71) Applicant: Visa International Service Association, San Francisco, CA (US)

(72) Inventors: Mahdi Zamani, San Francisco, CA (US); Adithya BHAT, San Francisco, CA (US)

(73) Assignee: Visa International Service Association, San Francisco, CA (US)

(21) Appl. No.: 19/481,165

(22) PCT Filed: May 6, 2024
(86) PCT No.: PCT/US2024/027967

§ 371 Date: Nov. 3, 2025

Related U.S. Application Data
(60) Provisional application No. 63/500,337, filed on May 5, 2023.

(51) Int. Cl. H04L 9/00; H04L 9/32; H04L 69/40

(52) U.S. Cl. CPC H04L 9/50; H04L 9/3255; H04L 69/40; H04L 2209/463

(57) ABSTRACT

A system for a verifying a transaction in a sharded blockchain network. The system comprises a plurality of worker shards that allows the system to scale the transaction processing power with the increase in the number of worker shards. The plurality of worker shards that allow multiple committees of nodes to process incoming transactions in parallel. A data shard coordinates the commitment of blocks to ensure that the highest block in a chain is accurately committed.

### CROSS-REFERENCE TO RELATED APPLICATION

This application claims the benefit of and priority under 35 U.S.C. § 119(e) to U.S. Provisional Application Ser. No. 63/500,337 filed May 5, 2023, entitled “A SYSTEM FOR PARTIALLY SYNCHRONOUS SCALABLE BLOCKCHAINS,” the contents of which is hereby incorporated by reference in its entirety herein.

### TECHNICAL FIELD

A method and system for processing interactions with a Byzantine fault tolerant state-machine replication protocol.

### SUMMARY

In one aspect, the present disclosure provides a method for a system for scalable block consensus in a blockchain network, the system comprising: a plurality of nodes further comprising: a plurality of worker shards, wherein each of the plurality of nodes is a distributed computing device, the plurality of nodes further comprising: a plurality of worker shards, wherein each worker shard of the plurality of worker shards comprises a first quantity of nodes of the plurality of nodes, and wherein the first quantity of nodes in each of the plurality of worker shards meets a first threshold for a safety parameter and a second threshold for a liveness parameter, and wherein the plurality of worker shards process transaction data corresponding to a plurality of blocks in the blockchain network; a reference shard, wherein the reference shard comprises a second quantity of nodes of the plurality of nodes, and wherein the second quantity of nodes meets a third threshold for the liveness parameter; and a data shard, wherein the data shard comprises a third quantity of nodes of the plurality of nodes, and wherein the third quantity of nodes meets a fourth threshold for the safety parameter; and wherein the system is configured to: establish a consensus for the transaction data by a first worker shard of the plurality of worker shards, wherein the first worker shard comprises a first set of nodes, and wherein the first worker shard determines the consensus based on a quorum of the first set of nodes; transmit a commit message to the data shard by the first worker shard, wherein the commit message comprises the consensus for the transaction; reorganize the plurality of nodes by the reference shard, based on an epoch interval, wherein the first worker shard is reorganized to comprise a second set of nodes of the plurality of nodes, wherein the second set of nodes is different from the first set of nodes, and wherein the second set of nodes is equal in quantity to the first quantity of nodes; and broadcast, by the data shard, a highest block number based on the commit message.

In another aspect, a method for establishing block consensus in a scalable blockchain network, the method comprising: generating, from a plurality of nodes, through epoch randomness for a first epoch of a plurality of epochs: a plurality of worker shards that meet a first threshold for a safety parameter and a second threshold for a liveness parameter; a reference shard that meets the second threshold for the liveness parameter; and a data shard that meets the second threshold for the liveness parameter; assigning, by the reference shard, a plurality of transactions to the plurality of worker shards for the first epoch of the plurality of epochs, wherein a first worker shard of the plurality of worker shards is assigned a first transaction of the plurality of transactions; maintaining, by the reference shard, a transaction repository, wherein the transaction repository identifies the plurality of transactions assigned to each of the plurality of worker shards; verifying, by the first worker shard, a commit message associated with the first transaction based on a predetermined number of signatures; transmitting, by the first worker shard, the commit message to the data shard, wherein the commit message comprises a block number corresponding to the first transaction; maintaining, by the data shard, a block repositor, wherein the block repository identifies a highest block committed by each of the plurality of worker shards; verifying, by the data shard, the block number is the highest block committed for the first worker shard; and broadcasting, by the data shard, an acknowledgement message corresponding to the commit message, wherein the acknowledgement message indicates that the commit message was verified.

In yet another aspect, a method for establishing block consensus in a scalable blockchain network, the method comprising: generating, from a plurality of nodes, through epoch randomness for a first epoch of a plurality of epochs: a plurality of worker shards that meet a first threshold for a safety parameter and a second threshold for a liveness parameter; a reference shard that meets the second threshold for the liveness parameter; and a data shard that meets the second threshold for the liveness parameter; assigning, by the reference shard, a plurality of transactions to the plurality of worker shards for the first epoch of the plurality of epochs; maintaining, by the reference shard, a transaction repository, wherein the transaction repository identifies the plurality of transactions assigned to each of the plurality of worker shards; maintaining, by the data shard, a block repository, wherein the block repository identifies a highest block committed by each of the plurality of worker shards; initiating, by the reference shard, a state transfer from the first epoch to a second epoch of the plurality of epochs; locking, by the reference shard, the data shard from committing new blocks during the state transfer; and reorganizing the plurality of node to generate a plurality of new worker shards based on the first threshold for the safety parameter and the second threshold for the liveness parameter.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 shows a blockchain transaction processing system 100 comprising a reference shard 108, a data shard 104, and a plurality of worker shards 106, according to at least one aspect of the present disclosure.

FIG. 2 shows the highest block number and corresponding hash of each worker shard 106, where m is the total number of worker shards in the system, according to at least one aspect of the present disclosure.

FIG. 3 shows a visual representation of voting process 300 for a plurality of nodes 102 in a worker shard 106, according to at least one aspect of the present disclosure.

FIG. 4 is a block diagram of a computer apparatus 400 with data processing subsystems or components, according to at least one aspect of the present disclosure.

FIG. 5 is a diagrammatic representation of an example system that includes a host machine within which a set of instructions to perform any one or more of the methodologies discussed herein may be executed, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

A “blockchain” can be a growing list of records linked by cryptography. A blockchain can include a series of blocks. Each block in the blockchain may include an electronic record of one or more historical transactions, as well as metadata. In some embodiments, blocks in the blockchain can be linked by including a reference to the previous block (e.g., a hash output of a previous block). Content in each new block in the blockchain may be algorithmically determined based on new transactions and previous blocks in the blockchain. The information in a blockchain can be immutable. A blockchain can be sharded into blockchain shards that are stored at committees. For example, a committee can store a shard of a blockchain, while a different committee can store a different shard of the blockchain.

A “verification network” can include a set of computer nodes programmed to provide verification for an interaction or transaction. A verification network may be a distributed computing system that uses several computer nodes that are interconnected via communication links. A verification network may be implemented using any appropriate network, including an intranet, the Internet, a cellular network, a local area network or any other such network or combination thereof. In some cases, nodes may be independently operated by third party or administrative entities. Such entities can add or remove computer nodes from the verification network on a continuous basis. In some embodiments, a node in a verification network may be a full node.

A “node” may be a point at which lines or pathways intersect or branch or can be a central or connecting point. In some cases, a node can be a “computer node,” which can be any computer or group of computers that can operate independently and within a network containing the node. In some embodiments, a node that can fully verify each block and interaction in the blockchain can be characterized as a “full node.” In some cases, a full node can store a full blockchain (i.e., each block and each interaction). In some cases, a client device may be a node computer in a verification network.

A “worker shard” can include a sub-group of nodes (e.g., node computers) of a network. A worker shard can include any suitable number of node computers of the network, and there may be any suitable number of worker shards in the network. In some cases, node computers in a worker shard can be validator nodes in a blockchain network. Node computers in a worker shard can maintain a blockchain or a portion of a blockchain. The portion may include a number of blocks of a blockchain, but not the entire blockchain. In some embodiments, each worker shard in a verification network may include the same number of node computers.

A “reference shard” can include a worker shard that can act as a reference for node computers in the network. A reference worker shard can include a number of node computers that can periodically reconfigure the worker shards in the network. Node computers of a reference shard can maintain and update a node-to-shard table and an interaction-to-shard table. Node computers of the reference shard can broadcast updates to the node-to-shard table and the interaction-to-shard table to the worker shards of the network. A reference shard can include an honest-majority of node computers.

A “block” can include a data element that holds records of one or more interactions, and can be a sub-component of a blockchain. A block can include a block header and a block body. A block can include a batch of valid interactions that are hashed and encoded into a Merkle tree. Each block can include a cryptographic hash of the prior block (or blocks) in the blockchain.

A “block header” can be a header including information regarding a block. A block header can be used to identify a particular block an a blockchain. A block header can comprise any suitable information, such as a previous hash, a Merkle root, a timestamp, and a nonce. In some embodiments, a block header can also include a difficulty value.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

“Interaction data” may be data associated with an interaction. For example, an interaction may be a transfer of a digital asset from one party to another party. The interaction data for example, may include a transaction amount and unspent transaction outputs (UTXOs). In some embodiments, interaction data can indicate different entities that are party to an interaction as well as value or information being exchanged. Interaction data can include a value, information associated with a sender (e.g., a token or account information, an alias, a device identifier, a contact address, etc.), information associated with a receiver (e.g., a token or account information, an alias, a device identifier, a contact address, etc.), one-time values (e.g., a random value, a nonce, a timestamp, a counter, etc.), and/or any other suitable information. An example of interaction data can be transaction data.

The term “verification” and its derivatives can include a process that utilizes information to determine whether an underlying subject is valid under a given set of circumstances. Verification may include any comparison of information to ensure some data or information is correct, valid, accurate, legitimate, and/or in good standing.

A “quorum value” can include a threshold number of votes. Each worker shard in a verification network can have a quorum value that indicates a number of votes needed to perform particular functions. For example, a leader node of a worker shard can propose a new block for the blockchain. Each node computer of the worker shard can vote on whether or not the new block should be included into the blockchain based on one or more criteria. If at least a quorum value number of node computers vote to include the new block in the blockchain, then the new block can be included in the blockchain.

An “accumulator value” can include a binding commitment on a set. An accumulator can be a one way membership function. An accumulator can accumulate one or more values (e.g., amounts, outputs, etc.) into an accumulator value. An accumulator can answer a query as to whether a potential candidate value is a member of the set (e.g., of accumulated values) without revealing the individual members of the set.

A “view number” can include a value that identifies a particular node computer. A view number can be a value that uniquely identifies a leader node computer of a particular worker shard. For example, each node computer of a worker shard can include a view number in any broadcast message, then check received messages to verify that the view number is the same in each message. Doing so, can verify that each node computer in the worker shard agrees that a particular node computer associated with the view number is the leader node computer for a current epoch.

A “block certificate” can include a data item that can act as evidence or proof of a block. A block certificate can be a threshold signature. The threshold signature can be generated based on individual signature shares from shares of a private key (e.g., shared through a worker shard). For example, when a node computer sends a vote message to vote for a block to be included into a blockchain, the node computer signs the vote message's hash digest with the node computer's share of a secret key of the node computer's worker shard. A quorum number of signatures on the vote message constitute a block certificate on the block.

A “propose message” can include a message that proposes an action or plan. A propose message can include a proposal to include a new block in a blockchain. A propose message can be broadcast by a node computer of a worker shard to other node computers of the worker shard. A propose message can include a new block that is to be proposed to the worker shard. A propose message can also include a view number and a block certificate of the previous block in the blockchain.

A “vote message” can include a message that votes for an action or plan. A vote message can be provided in response to a propose message. A vote message can include an indication that the message is a vote message and/or a vote (e.g., yes, no, 0, 1, etc.). A vote message can include a view number and a new block that is proposed to be added to a blockchain (e.g., as proposed in a propose message).

A “pre-commit message” can include a message that indicates precommitment to an action or plan. A pre-commit message can be provided in response to vote messages if there is no equivocation in a worker shard. A pre-commit message can include a view number. A pre-commit message can also include a new block that is to that is proposed to be added to a blockchain (e.g., as proposed in a propose message) and is voted to be added to the blockchain (e.g., as voted in a vote message). A pre-commit message can also include a block certificate for the new block.

A “commit interaction request message” can include a message requesting commitment of an interaction. A commit interaction request message can include interaction data and one or more proof-of-inclusions. A commit interaction request message can be sent from a client device to a node computer in a worker shard to request that an interaction (e.g., a transaction) be included in a blockchain maintained by the worker shard.

A “proof-of-inclusion” can include evidence that something is included in something else. A proof-of-inclusion can include evidence that an amount such as an unspent transaction output (UTXO) is or was included in a block of a blockchain.

For example, a client device or node in a worker shard can request a proof-of-inclusion of an amount x from a first worker shard, such that a transaction can be committed to in a second worker shard. The proof-of-inclusion can attest that the output (e.g., UTXO of the first worker shard) referenced by an input (e.g., an amount that will be spend at the second worker shard) is stored in the blockchain maintained the first worker shard and, in some cases, that the output has been removed for the transaction. A proof-of-inclusion can include a Merkle tree, a block header, and a commitment proof that a block associated with the block header is included in a blockchain.

A “shutdown message” can include a message that requests closure. A shutdown message can request closure of a worker shard. A plurality of honest node computers of a worker shard may generate and transmit shutdown messages to a reference worker shard to request that the worker shard be closed for a current epoch. A shutdown message can include a request to close a worker shard and a worker shard identifier. In some embodiments, a shutdown message can include a reason for the requested shutdown (e.g., vote inactivity, pre-commit inactivity, view-change inactivity, a view-change bound, etc.). In some embodiments, a shutdown message can be created if an inactivity timer reaches zero (e.g., indicates that the state of a worker shard is inactive).

An “inactivity timer” can include a mechanism for detecting a state of being inactive. An inactivity timer can be set locally by each node computer in a worker shard. An inactivity timer can be set to a predetermined amount of time.

For example, an inactivity timer can be set to a value of two times an upper bound on the message delivery time (e.g., 2Δ). A node computer can set the inactivity timer to the predetermined amount of time after performing an action to which the node computer expects a response. The inactivity timer can count down to zero as time progresses with no actions taking place.

A “propose table update message” can include a message that proposes an updated table. A propose table update message can include a node-to-shard table. A propose table update message can be broadcast by one or more node computers in a reference worker shard to a node computers in a plurality of worker shards in a network.

A “node-to-shard table” can include a table that associates computer nodes with worker shards. A node-to-shard table can be a reference table that associates each computer node in a network with a worker shard in the network. A node-to-shard table can indicate which computer nodes are assigned to which worker shards for a current epoch. In some embodiments, a node-to-shard table can include a null worker shard as one of the worker shards in the table. The null worker shard can be a worker shard that groups together computer nodes that will not be in worker shards that process interactions during the current epoch. A node-to-shard table can be maintained by a reference worker shard in the network. A node-to-shard table can include node computer identifiers for the node computers and shard identifiers for the worker shards. In some embodiments, the node-to-shard table can include an IP address or other communication information of each node computer.

An “interaction-to-shard table” can include a table that associates interactions with worker shards. An interaction-to-shard table can be a reference table that associates each new interaction (e.g., new interactions provided to the network) to a worker shard in the network. An interaction-to-shard table can be maintained by a reference worker shard in the network. A reference worker shard can associate new interactions with worker shards based on a determined hash of the new interaction.

A “commitment process” can include a series of steps taken to commit to a value. A commitment process can include node computers of a worker shard determining whether or not to commit to a particular action (e.g., including a new block in a blockchain, updating a node-to-shard table, etc.) and committing to the action. A commitment process can occur after a node computer (e.g., a leader node) proposes an action to a plurality of node computers in a worker shard. A commitment process can include providing vote messages and pre-commit messages regarding the proposed action. A commitment process can result in a commitment to the action based on at least the pre-commit messages. In some embodiments, a quorum value number of pre-commit messages may be needed to commit to an action.

In various aspects, the present disclosure describes a system for verifying a transaction in a sharded blockchain network that scales the transaction processing power with the increase in the number of worker shards. The system employs a plurality of worker shards that allow multiple committees of nodes to process incoming transactions in parallel. Thus, the total number of transactions processed in each consensus round by the entire protocol is multiplied by the number of committees (e.g., worker shards).

In one example, a sharded consensus protocol is configured for a fault tolerance of ⅓ corruption that allows the protocol to achieve a complete sharding of the communication, computation, and storage overhead of processing transactions, without assuming any trusted setup. The shard consensus protocol employs an intra-committee consensus algorithm that can achieve high throughput via block pipelining, a gossiping protocol for large blocks, and a reconfiguration mechanism based on cuckoo rule.

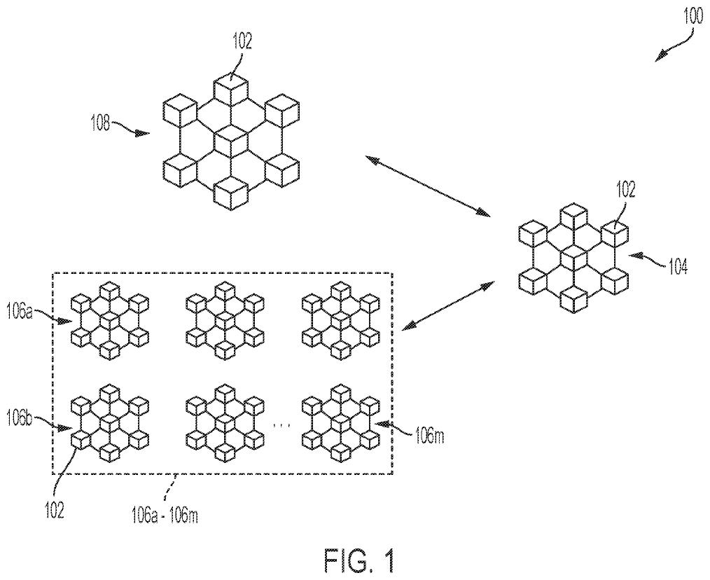

FIG. 1 shows a blockchain transaction processing system 100 comprising a reference shard 108, a data shard 104, and a plurality of worker shards 106, according to at least one aspect of the present disclosure. The reference shard 108, data shard 104, and the plurality of worker shards 106 each comprise a plurality of nodes 102 that are randomly assigned and periodically reorganized, in order to balance the transaction processing speeding and shard integrity. The plurality of worker shards 106 establish consensus on proof values calculated by each of the plurality of nodes for a plurality of transactions. This configuration allows the plurality of worker shards 106 to establish consensus, in parallel, on a plurality of sub-chains. Each of the worker shards 106 processes transactions in parallel in order to establish a quorum for the transaction. A quorum is established by a vote of each node 102 in the worker shard 106 and a commit message is sent to the data shard 104. A quorum may be reached according to a quorum certificate and the worker shard 106 commits the transaction as a block on the blockchain. The data shard 104 coordinates the parallel processing of the plurality of worker shards 106, allowing the plurality of sub-chains to appear as a single blockchain system. The system employs a Byzantine fault tolerant state-machine replication (BFT SMR) protocol to coordinate the transaction processing and ensure shard integrity for the plurality of worker nodes 106.

In a blockchain system that employs a BFT SMR protocol, a group of nodes in a worker shard 106 can attempt to agree on a sequence of values without the help of a third party. In some cases, some of the nodes 102 in a worker shard 106 may be faulty nodes controlled by a Byzantine adversary that intentionally tries to hinder the commitment of transactions. These faulty nodes may be referred to as Byzantine server or Byzantine nodes. The faulty nodes or corrupt nodes arbitrarily deviate from the protocol. However, the BFT SMR protocol is tolerant for a predetermined amount of corrupt nodes to ensure that the worker shard 106 is still capable of correctness, or committing a correct block. The correctness of a state-machine replication protocol can be evaluated based on two properties, safety of the worker shard and liveness of the worker shard. A safety requirement guarantees that all honest nodes process the same sequence of interactions (e.g., transactions). In one example, if two honest nodes output the values tx and tx′ for a transaction at a position p, it is assumed that tx and tx′ must be the same. The liveness requirement ensures that all correct interactions are eventually processed (e.g., the interaction does not remain pending indefinitely or stuck in a deadlock where a quorum cannot be reached). Accordingly, when a worker shard 106 establishes consensus on an interaction, based on a quorum number of nodes in a quorum certificate, a block is locked for the interaction and sent to the data shard 104 to be committed.

The solvability of state-machine replication may depend on a maximum number of corrupt nodes allowed depending on the network synchrony assumptions. For example, under a synchronous network assumption, an honest majority of nodes may be needed. Under a partially-synchronous network, the fraction of corrupt nodes can be bounded from above by ⅓, for example. Further, no deterministic asynchronous protocol can solve the state-machine replication. To avoid this impossibility and/or to achieve practicality, various embodiments can provide probabilistic safety or liveness guarantees. In the latter case, embodiments can provide eventual liveness (or eventual consistency) since nodes can decide on a value with probability one, but with no time bound. In this example, the sharding protocol may intentionally sacrifice the liveness requirement, while maintaining the safety requirement, to increase the processing speed of the integration. Accordingly, the present disclose describes a system that balances the liveness requirements of the worker shards with the interest of consensus speed for the interactions.

The present disclosure addresses the tension between speed and shard integrity by utilizing the honest nodes within the plurality of worker shards 106, a reference shard 108, and a data shard 104. The reference shard 108 can be a distinguished, honest-majority shard that is tasked with periodically reconfiguring the worker shards 106 (e.g., whereas other shards are tasked with processing interactions) as well as maintaining and updating various look-up tables. For example, the reference shard 108 can maintain two look-up tables: 1) a node-to-shard table that shows which node is assigned to which shard, and 2) an interaction-to-shard table that specifies how interactions are assigned to worker shards. The reference shard 108 reassigns the worker shards 106 and updates the two look-up tables for each epoch randomness event. The epoch randomness event is a periodic and random reorganization of the plurality of nodes 102 that make up each of the worker shards 106.

In various aspect, the data shard 104 applies a state-transfer protocol that ensure block state consistency between shard 1 in a first epoch, e, and shard 1 in the second epoch, e+1. For each epoch randomness event, the nodes 102 are randomly assigned and reorganized into new worker shards 106. In one example, each worker shard is associated with a number in a table from 1 to m. A first node 102 was assigned to shard 1 and a first epoch e and reassigned to shard 5 after epoch randomness of the second epoch e+1. This process creates a random probability that the majority of nodes 102 in a worker shard 106 are honest nodes, and decreases the possibility that corrupt nodes are able to work together to hinder the processing of the worker node 106. The random epochs may be performed in random interval or fixed intervals. In one aspect, random epoch is performed every 24 hours. The random epochs establish a balance between the worker shard size and the shard integrity. For example, a smaller shard size can establish a consensus faster when all of the nodes are honest, but is easier to corrupt with faulty nodes. Additionally, the reference shard 108 and the data shard 104 may be re-sharded with a random group of nodes 102. Although, the reference shard 108 and the data shard 104 are required to meet higher liveness and/or safety requirements than the worker shards 106, they may also be susceptible to corruption. Accordingly, the reference shard 108 and the data shard 104 may also undergo a periodic re-sharding process.

The state-transfer protocol allows the data shard 104 to verify the highest locked block on the chain, and may broadcast the highest block number. An acknowledgement of the highest block in the chain may be determined by the reference shard 108. In one example, once the data shard 104 sends 2n/3+1 verification messages to the reference shard 108 of the highest block in the chain, the block can be committed, where n is the total number of nodes in the data shard 104. This solution is specific for a partial-synchronous system because the liveness property is sacrificed. Therefore, the system cannot wait because liveness is not guaranteed for the shard.

In various aspects, the broadcast message may be distributed to the worker shards 106 as a Byzantine consistent broadcast (e.g., Crusader Agreement). The primitive nature of the Byzantine consistent broadcast guarantees: (1) validity of the value sent by a correct sender is the value output by the protocol; (2) that the protocol eventually terminates; and (3) agreement among all nodes on the same value output value. However, termination and validity are not guaranteed for the Byzantine senders. Nonetheless, this only occurs when a shard is Byzantine (e.g., exceeds a predetermined number of adverse nodes) and, as such, any value picked by the reference shard 108 in the new epoch is safe.

In one example, the blockchain transaction processing system 100 comprises N total servers. The N total servers further comprises three types of server groups: m worker shards S1, . . . , Sm wherein each of the worker shards 106 consist of n servers each, a reference shard SR with nR servers, and a data shard 104, SD with nD servers. Trivially, N=mn+nR+nD. A worker shard Sj consists of n servers pj1, . . . , pjn. Although this notation includes the term j, j is omitted when referring to a generic worker shard server. Similarly, the reference shard 108 and data shard 104 are pR1, . . . , pR nR and pD1, . . . , pD nD respectively.

A worker shard 106, Sj, is identified by a public key pkj, and the public keys of the reference 108 and worker shards 106 are denoted by pkR and pkD respectively. The secret key of a server pji in shard Sj is sk ji. The notation omits j when referring to a generic worker shard server 106 and <m>j,i denotes a signed message by pji. Algorithm 1 shows an instachain intra-shard SMR Protocol, for server i. Algorithm 1 uses “←” to denote assignment, “=” to denote equality check, and “:=” to denote parsing into components.

State Machine Replication. In a State Machine Replication protocol, a set of servers give the clients an interface akin to a single state machine. The clients (may include servers) send requests called transactions, which is processed by the servers and the results are returned to the clients. A state machine replication protocol emulates a single state machine that executes client's requests by building a linearizable log of requests satisfying the following two properties: (1) safety, for any position p in the log, no two servers disagree on the transaction in this position; and (2) liveness, where all client requests are eventually processed by the system.

Typically, to tolerate f Byzantine faults, the client waits for f+1 identical responses from servers in order to accept the result. There may be several strategies to communicate the results of an execution securely to the clients with various security and scalability trade-offs. As this is an independent orthogonal problem, the SMR protocol instead focuses on the algorithms run by the servers to build the log of client requests.

Blocks and chains. In various aspects, the blockchain transaction processing system 100 receives a batch of client requests denoted by “Cmds” (e.g., commands) in blocks, denoted by B. A log is realized by building a consistent sequence of blocks called a chain. A block is added to the chain with parent being the last block in the sequence by:
block.parent←H(parent)
block.contents←Cmds
block.qc←qc

Overview of the Flow of Execution. Our protocol proceeds in epochs where nodes have access to a fresh randomness at the beginning of each epoch. Using the randomness, nodes are first assigned to the shards. In the very first epoch, this randomness (e.g., epoch randomness) can be generated by a one-time bootstrapping protocol. In the later epochs, the reference shard 108 (described below) is tasked with generating the randomness for the next epoch at the end of the ongoing one.

There are two types of shards in SMR protocol: the reference shard 108, and the worker shards. The reference shard 108 is a distinguished shard that is tasked with the organization of the worker shards between and during epochs. On the other hand, worker shards process transactions that are submitted by external users. A node (e.g., server) can participate in both the reference shard 108 and a worker shard but not more than one worker shard. Further, the reference shard 108 is guaranteed to satisfy both the safety parameter and the liveness parameter of the SMR. In contrast, some worker shards might satisfy only the safety parameter, and hence can be inactive.

After the three shard groups are formed, each worker shard first runs a distributed key generation (DKG) protocol. Hash digest of the generated public key is referred as to as a shard's identity, and each node within the worker shard receives a share of the corresponding secret key. Once the DKG is completed, members of the shard sign and submit their shard's identity to the reference shard 108, as further discussed below. Upon receiving a predetermined number of signed messages from a worker shard, the reference shard 108 assigns a set of transactions to that worker shard by modifying his transaction-to-shard table, as further discussed below. After waiting for a predetermined amount of time, the reference shard 108 broadcasts the transaction-to-shard table to the shards within the network. Safe shards may be excluded from processing transactions for the ongoing epoch in case they do not complete this step within the predetermined amount of time (e.g., if corrupt nodes in such shards stay inactive). The experiments, waiting the predetermined amount of time, will decide whether this approach makes sense.

Then, the worker shards start to process transactions and build their local ledgers by running an intra-shard SMR protocol in a stateless blockchain model. This means that the nodes within the worker shards only maintain an accumulator computed over the ledger state. It is up to the clients to keep track of the explicit state of the ledgers by listening to the network. The explicit state is needed to generate membership proofs on transactions' inputs. In one example, a transaction may be spread over multiple worker shards. In this a case, the clients may facilitate the verification between involved shards by running a cross-shard verification protocol.

Finally, a safe shard can begin an epoch as active, but might become inactive at any time during the epoch. The inactive shards are eventually detected and closed or decommissioned by the reference shard 108 within an epoch. When a shard is closed, the reference shard reassigns its transactions to one of the active shards to take over and continue building upon the closed shard's state.

Intra-Shard Key Generation. After all nodes are assigned to a worker shard (e.g., first worker shard 106a, second worker shard 106b, mth worker shard 106m), each worker shard 106 internally runs a distributed key generation (DKG) protocol. The goal is to utilize a threshold signature scheme (e.g., Boneh-Lynn-Shacham signature threshold) to minimize the communication complexity. Shards that successfully complete this step are authenticated by the reference shard 108, and only those are allowed to process transactions in the current epoch.

After running a DKG protocol, a shard S generates a key-pair (skS, pkS) such that, pkS is a shared public key (where we refer to its hash digest H(pkS) as shard's identity) and the skS i s the corresponding secret key which is verifiably q-out-of-n shared among the nodes of S. After this step, each node r of S generates a signature share <H(pkS)>r on his shard's identity using his share of the secret key. Then, every node 102 sends their share of the signature to the reference shard 108. After accumulating q of these shares, reference shard 108 constructs the threshold signature and verifies it with pkS.

Once the reference shard 108 constructs and verifies the threshold signatures, the reference shard 108 adds S to the transaction-to-shard table by assigning S to its share of transactions (see discussion below for assigning transactions to shards). After waiting a sufficient time to receive enough shares from all the shards, the reference shard 108 commits the transaction-to-shard table to his state, and broadcasts it to the network. Upon receiving this table, shards can start to process transactions that they are assigned to.

Note that, it is possible for corrupt nodes in a safe shard S′ to stall the DKG protocol, e.g., by staying silent. However, in this case, S′ is excluded from the transaction-to-shard table, and every node of it is assigned to ⊥ in the node-to-shard assignment table. This indicates that, transactions are not routed to S′, and (honest) nodes within S′ do not participate in intra-shard SMR. This effectively closes S′ for the current epoch.

Assigning Transactions to Shards. When assigning new transactions to shards, there are two factors to consider: first, we must ensure that every transaction is uniquely assigned to a shard to maintain consistency, and second, we should take load-balancing into account while doing so. In this section, we describe how we achieve these in the SMR protocol.

As noted before, the reference shard 108 is tasked with maintaining and updating a transaction-to-shard table. Nodes 102 within the worker shards 106 receive the transaction-to-shard table from the reference shard 108, at the beginning of each epoch, and perform lookups on the table to determine whether a transaction is assigned to their shard or not. This transaction-to-shard table is implemented as a complete binary search tree. The complete binary search tree comprises the shard identifiers as the leaves in the tree, and the path from the root to a leaf specifies the prefix of the hashes of transactions that the shard is assigned. For example, if the path from the root to a shard S is 00, S processes transactions whose first 2 bits are 00. As new shards are created or the existing ones are closed, the reference shard 108 transaction-to-shard table organizes the tree accordingly and broadcasts the updated table to the network.

Intra-Shard SMR. The intra-shard SMR protocol, as described in Algorithm 1, is configured to satisfy the safety parameter for safe shards and satisfy both the safety parameter and liveness parameter for super-honest shards. The intra-shard SMR protocol implements the SMR abstraction by building a consistent sequence of blocks. The blocks contain requests sent by the clients which represent commands to the state machine. A client sends the request to the worker shard(s) responsible (which it learns by contacting the reference shard 108) and waits for q+1 responses from the servers in a shard.

The intra-shard SMR protocol uses three monotonically increasing counters: epoch, view, and round. The epoch represents the current distribution of servers into shards, the view refers to the current configuration of a shard with a specified unique leader, and the round refers to the proposal of a leader within a view in the epoch.

A key-ingredient of the intra-shard SMR protocol, calculated by Algorithm 2, is the use of q+1 sized certificates and (n+q)/2 sized certificates. The first certificate ensures that at least one honest server attests to a statement, while the second certificate ensures that the majority of the honest nodes (even if they are in minority) attest to a statement. The first certificate is referred to as a SafeQC and the second certificate is referred to as an OptimisticQC. The protocol maintains the following state variables: L tracks the current leader, rcur tracks the current round, vcur tracks the current view, and ecur tracks the current epoch.

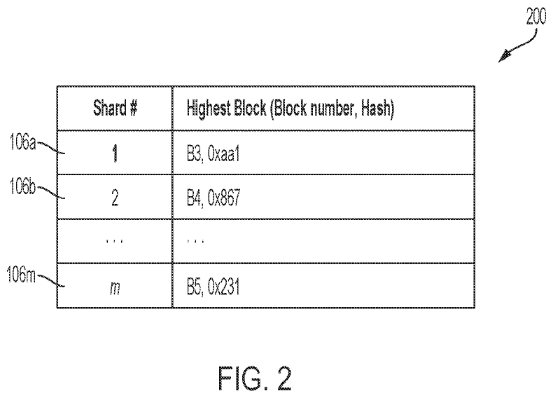

FIG. 2 shows a block table 200 comprising the highest block number and corresponding hash of each worker shard 106, where m is the total number of worker shards in the system, according to at least one aspect of the present disclosure. In various aspects, a data shard 104 may maintain the block table 200. Once a worker shard 106 reaches consensus, the worker shard locks the block for the interaction and send a commit message to the data shard 104 with the block number and the hash value. The commit message ensures that the locked block is the highest block and that the worker shard 106 is in lock step with the other worker shards. The worker shard 106 waits for the data shard 104 to broadcast an acknowledgement message to confirm the block number and commits the block to the chain. The block verification process is particularly important for new epochs that reorganize the worker shards 106. The block verification process ensures that the new worker shards 106 are picking up where the previous worker shards 106 left off, and there is a consistent state transfer between the new epoch worker shards. During the epoch randomness event, the reference node 108 locks the data shard 104 to prevent the data shard 104 from locking new blocks by worker shards 106, and receives the highest block number from the previous epoch, e.

In various aspect, the SMR protocol of the present disclosure describes the shard size and quorum with the following terms: N is the total number of servers or nodes in the system, F is the total number of Byzantine servers in the system, m is the total number of shards in the system, f is the total number of faulty nodes in each shard, and n is the total number of nodes in each shard, wherein each shard tolerates up to q number of Byzantine servers. The SMR protocol comprises a quorum certificate that defines liveness and safety for both partial synchrony and synchrony, of the worker shards. In one aspect, the SMR protocol optimizes safety but not liveness by using (n+q)/2 and q+1 sized certificates. This quorum certificate ensures that the SMR protocol is safe when f<q (if committed, all servers agree) and live (e.g., makes progress) when f<n/3 for partial synchrony and f<n/2 for synchrony.

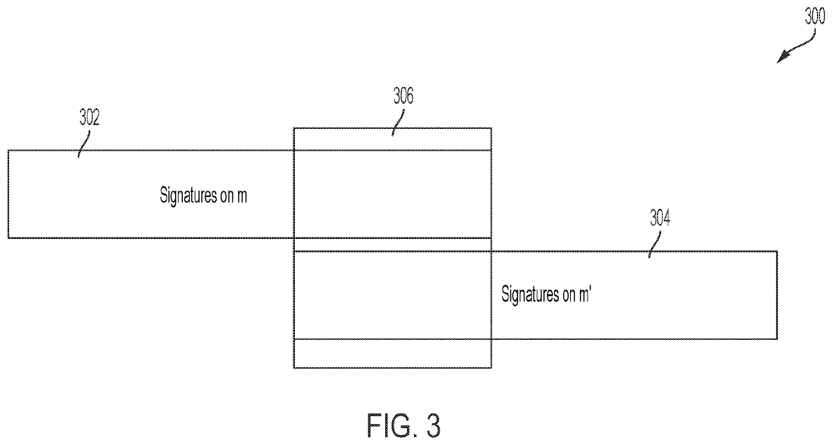

FIG. 3 shows a visual representation of voting process 300 for the plurality of nodes 102 in a worker shard 106, according to at least one aspect of the present disclosure. The quorum certificate size prevents two different messages, a correct message 302, m, and an incorrect message 304, m′, from both being certified. Additionally, Byzantine servers may vote or sign for multiple messages. However, a quorum certificate size of (n+q)/2 ensures that only one message is certified when up to q number of nodes are Byzantine servers. In this example, the Byzantine servers voted for both messages m 302 and m′ 304. Only one message is certified if union 306 of the set of signatures or votes (2X−q) is less than the total number of nodes, n, in the worker shard 106. Thus, the safety parameter may require 2X−q>n or X>(n+q)/2, where x is the total number of signatures for a message. Once a message receives (n+q)/2 votes, the proposed block is locked and sent to the data shard 104 for acknowledgement.

In various aspect, the state transfer protocol requires that the data shard 104 meet n>3f, for asynchronous liveness requirement, where n is the total number of nodes in the data shard 104, and f is the number of faulty nodes in the data shard 104.

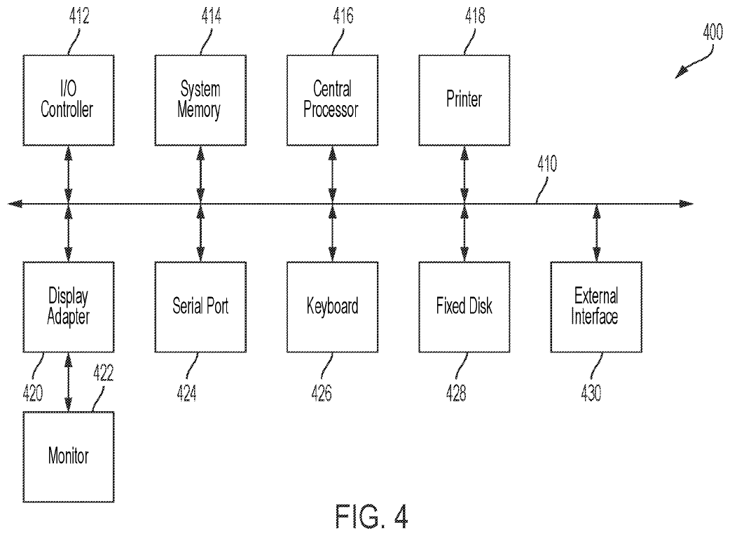

FIG. 4 is a block diagram of a computer apparatus 400 with data processing subsystems or components, according to at least one aspect of the present disclosure. The subsystems shown in FIG. 4 are interconnected via a system bus 410. Additional subsystems such as a printer 418, keyboard 426, fixed disk 428 (or other memory comprising computer readable media), monitor 422, which is coupled to a display adapter 420, and others are shown. Peripherals and input/output (I/O) devices, which couple to an I/O controller 412 (which can be a processor or other suitable controller), can be connected to the computer system by any number of means known in the art, such as a serial port 424. For example, the serial port 424 or external interface 430 can be used to connect the computer apparatus to a wide area network such as the Internet, a mouse input device, or a scanner. The interconnection via system bus allows the central processor 416 to communicate with each subsystem and to control the execution of instructions from system memory 414 or the fixed disk 428, as well as the exchange of information between subsystems. The system memory 414 and/or the fixed disk 428 may embody a computer readable medium.

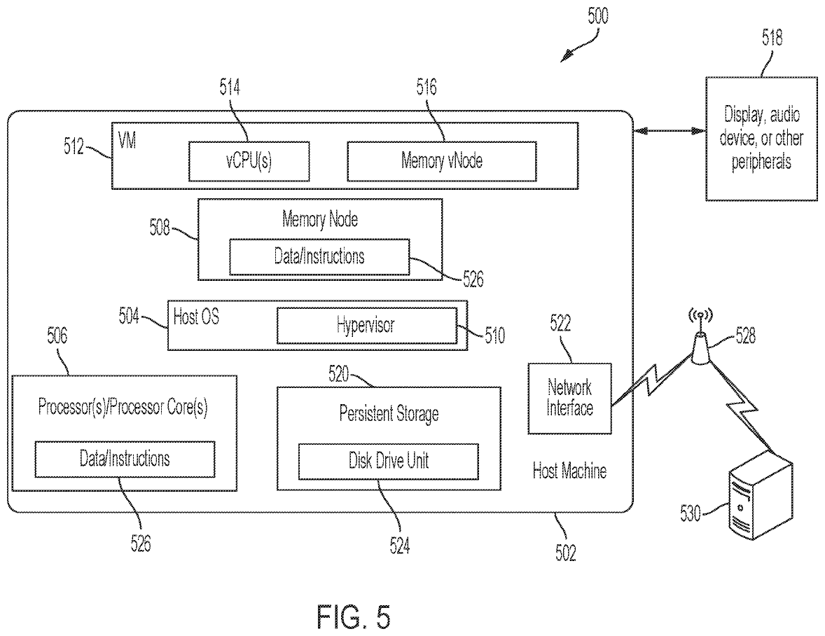

FIG. 5 is a diagrammatic representation of an example system 500 that includes a host machine 502 within which a set of instructions to perform any one or more of the methodologies discussed herein may be executed, according to at least one aspect of the present disclosure. In various aspects, the host machine 502 operates as a standalone device or may be connected (e.g., networked) to other machines. In a networked deployment, the host machine 502 may operate in the capacity of a server or a client machine in a server-client network environment, or as a peer machine in a peer-to-peer (or distributed) network environment. The host machine 502 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 500 includes the host machine 502, running a host operating system (OS) 504 on a processor or multiple processor(s)/processor core(s) 506 (e.g., a central processing unit (CPU), a graphics processing unit (GPU), or both), and various memory nodes 508. The host OS 504 may include a hypervisor 510 which is able to control the functions and/or communicate with a virtual machine (“VM”) 512 running on machine readable media. The VM 4012 also may include a virtual CPU or vCPU 514. The memory nodes 508 may be linked or pinned to virtual memory nodes or vNodes 516. When the memory node 508 is linked or pinned to a corresponding vNode 516, then data may be mapped directly from the memory nodes 4008 to their corresponding vNodes 516.

All the various components shown in host machine 502 may be connected with and to each other, or communicate to each other via a bus (not shown) or via other coupling or communication channels or mechanisms. The host machine 502 may further include a video display, audio device or other peripherals 518 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 520 (also referred to as disk drive unit), and a network interface device 522. The host machine 502 may further include a data encryption module (not shown) to encrypt data. The components provided in the host machine 502 are those typically found in computer systems that may be suitable for use with aspects of the present disclosure and are intended to represent a broad category of such computer components that are known in the art. Thus, the system 500 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 524 also may be a Solid-state Drive (SSD), a hard disk drive (HDD) or other includes a computer or machine-readable medium on which is stored one or more sets of instructions and data structures (e.g., data/instructions 526) embodying or utilizing any one or more of the methodologies or functions described herein. The data/instructions 526 also may reside, completely or at least partially, within the main memory node 508 and/or within the processor(s) 4006 during execution thereof by the host machine 502. The data/instructions 526 may further be transmitted or received over a network 528 via the network interface device 522 utilizing any one of several well-known transfer protocols (e.g., Hyper Text Transfer Protocol (HTTP)).

The processor(s) 506 and memory nodes 508 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 502 and that causes the host machine 502 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 502, with each server 530 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

Clause 1. A system for scalable block consensus in a blockchain network, the system comprising: a plurality of nodes further comprising: a plurality of worker shards, wherein each worker shard of the plurality of worker shards comprises a first quantity of nodes of the plurality of nodes, and wherein the first quantity of nodes meets a first threshold for safety, and wherein the plurality of worker shards process interactions corresponding to a plurality of blocks in the blockchain network; a reference shard, wherein the reference shard comprises a second quantity of nodes of the plurality of nodes, and wherein the second quantity of nodes meets a second threshold for a safety requirement and a liveness requirement; and a data shard, wherein the data shard comprises a third quantity of nodes of the plurality of nodes, wherein the system is configured to: receive a transaction by a first worker shard of the plurality of worker shards; establish a consensus for the transaction by the first worker shard, wherein the first worker shard comprises a first set of nodes that determines the consensus based on a quorum of nodes; transmit a commit message to the data shard by the first worker shard, wherein the commit message comprises the consensus for the transaction; reorganize the plurality of nodes by the reference shard, based on an epoch interval, wherein the first worker shard is reorganized to comprise a second set of nodes of the plurality of nodes, wherein the second set of nodes is different from the first set of nodes, and wherein the second set of nodes is equal in quantity to the first quantity of nodes; and broadcast, by the data shard, a highest block number based on the commit message.

Clause 2. The system of clauses 1, wherein the consensus for the transaction by the first worker shard is determined by a quorum certificate.

Clause 3. The system of clause 2, wherein the quorum certificate requires the quorum of nodes to exceed (n+q)/2 signature by the first worker node, where n is a total number of nodes in each of the plurality of worker shards and q is a total number of nodes needed to establish the quorum of nodes in each of the plurality of worker shards.

Clause 4. The system of clauses 1-3, wherein the liveness requirement determines the number of nodes in the each of the plurality of worker shards that are needed to reach the quorum of nodes without the plurality of worker shards stalling indefinitely.

Clause 5. The system of clauses 1-4, wherein the commit message comprises a hash value for one of the plurality of blocks.

Clause 6. The system of clauses 1-5, wherein the data shard comprises a table corresponding to the highest block number associated with each of the plurality of worker shards.

Clause 7. The system of clauses 1-6, wherein the first threshold for safety of the plurality of worker shards is defined by f<q<n, where f is the total number of faulty nodes in each of the plurality of worker shards, q is the total number of nodes needed to establish the quorum of nodes in each of the plurality of worker shards, and n is the total number of nodes in each of the plurality of worker shards.

Clause 8. The system of clauses 1-7, wherein the first threshold for liveness of the plurality of worker shards is defined by f<n/3, where f is the total number of faulty nodes in each of the plurality of worker shards, and n is the total number of nodes in each of the plurality of worker shards.

Clause 9. A system for scalable block consensus in a blockchain network, the system comprising: a plurality of nodes, wherein each of the plurality of nodes is a distributed computing device, the plurality of nodes further comprising: a plurality of worker shards, wherein each worker shard of the plurality of worker shards comprises a first quantity of nodes of the plurality of nodes, and wherein the first quantity of nodes in each of the plurality of worker shards meets a first threshold for a safety parameter and a second threshold for a liveness parameter, and wherein the plurality of worker shards process transaction data corresponding to a plurality of blocks in the blockchain network; a reference shard, wherein the reference shard comprises a second quantity of nodes of the plurality of nodes, and wherein the second quantity of nodes meets a third threshold for the liveness parameter; and a data shard, wherein the data shard comprises a third quantity of nodes of the plurality of nodes, and wherein the third quantity of nodes meets a fourth threshold for the safety parameter; and wherein the system is configured to: establish a consensus for the transaction data by a first worker shard of the plurality of worker shards, wherein the first worker shard comprises a first set of nodes, and wherein the first worker shard determines the consensus based on a quorum of the first set of nodes; transmit a commit message to the data shard by the first worker shard, wherein the commit message comprises the consensus for the transaction data; reorganize the plurality of nodes by the reference shard, based on an epoch interval, wherein the first worker shard is reorganized to comprise a second set of nodes of the plurality of nodes, wherein the second set of nodes is different from the first set of nodes, and wherein the second set of nodes is equal in quantity to the first quantity of nodes; and broadcast, by the data shard, a highest block number based on the commit message.

Clause 10. The system of Clause 9, wherein the consensus for the transaction data by the first worker shard is determined by a quorum certificate.

Clause 11. The system of Clause 10, wherein the quorum certificate requires the quorum of nodes to exceed x number ofsignatures by the first worker shard, where x>(n+q)/2, and wherein n is a total number of nodes in each of the plurality of worker shards, and q is a total number of nodes needed to establish the quorum of nodes in each of the plurality of worker shards.

Clause 12. The system of Clause 11, wherein q defines the total number of nodes needed to establish the quorum of nodes in each of the plurality of worker shards, wherein f is a total number of faulty nodes in the first worker shard, and wherein q=n−f.

Clause 13. The system of Clauses 9-12, wherein the liveness parameter determines the number of nodes in each of the plurality of worker shards that are needed to reach the quorum of nodes without the plurality of worker shards stalling indefinitely.

Clause 14. The system of Clauses 9-13, wherein the commit message comprises a hash value for one of the plurality of blocks.

Clause 15. The system of Clauses 9-14, wherein the data shard comprises a table corresponding to the highest block number associated with each of the plurality of worker shards.

Clause 16. The system of Clauses 9-15, wherein the first threshold for the safety parameter of the plurality of worker shards is defined by f<q<n, where f is a total number of faulty nodes in each of the plurality of worker shards, q is the total number of nodes needed to establish the quorum of nodes in each of the plurality of worker shards, and n is the total number of nodes in each of the plurality of worker shards.

Clause 17. The system of Clause 16, wherein the second threshold for the liveness parameter of the plurality of worker shards is defined by f<n/3, where f is the total number of faulty nodes in each of the plurality of worker shards, and n is the total number of nodes in each of the plurality of worker shards.

Clause 18. The system of Clause 16, wherein the second threshold for the liveness parameter of the plurality of worker shards is defined by f<n/2, where f is the total number of faulty nodes in each of the plurality of worker shards, and n is the total number of nodes in each of the plurality of worker shards.

Clause 19. The system of Clause 9-18, wherein the third threshold for the liveness parameter of the reference shard is defined by f<n/3, where f is a total number of faulty nodes in the reference shard, and n is the total number of nodes in the reference shard.

Clause 20. The system of Clause 9-19, wherein the fourth threshold for the liveness parameter of the data shard is defined by f<n/3, where f is a total number of faulty nodes in the data shard, and n is the total number of nodes in the data shard.

Clause 21. A method for establishing block consensus in a scalable blockchain network, the method comprising: generating, from a plurality of nodes, through epoch randomness for a first epoch of a plurality of epochs: a plurality of worker shards that meet a first threshold for a safety parameter and a second threshold for a liveness parameter; a reference shard that meets the second threshold for the liveness parameter; and a data shard that meets the second threshold for the liveness parameter; assigning, by the reference shard, a plurality of transactions to the plurality of worker shards for the first epoch of the plurality of epochs, wherein a first worker shard of the plurality of worker shards is assigned a first transaction of the plurality of transactions; maintaining, by the reference shard, a transaction repository, wherein the transaction repository identifies the plurality of transactions assigned to each of the plurality of worker shards; verifying, by the first worker shard, a commit message associated with the first transaction based on a predetermined number of signatures; transmitting, by the first worker shard, the commit message to the data shard, wherein the commit message comprises a block number corresponding to the first transaction; maintaining, by the data shard, a block repositor, wherein the block repository identifies a highest block committed by each of the plurality of worker shards; verifying, by the data shard, the block number is the highest block committed for the first worker shard; and broadcasting, by the data shard, an acknowledgement message corresponding to the commit message, wherein the acknowledgement message indicates that the commit message was verified.

Clause 22. The method of Clause 21, further comprising: initiating, by the reference shard, a state transfer from the first epoch to a second epoch of the plurality of epochs; locking, by the reference shard, the data shard from committing new blocks during the state transfer; reorganizing the plurality of nodes to generate a plurality of new worker shards based on the first threshold for the safety parameter and the second threshold for the liveness parameter; and performing, by the plurality of new worker shards, a transaction lookup in the transaction repository, wherein the transaction repository indicates a last transaction processed by each of the plurality of new worker shards.

Clause 23. The method of Clauses 21-22, wherein: the first threshold for the safety parameter of the plurality of worker shards is defined by f<q<n, where f is a total number of faulty nodes in each of the plurality of worker shards, q is the total number of nodes needed to establish the quorum of nodes in each of the plurality of worker shards, and n is the total number of nodes in each of the plurality of worker shards; and the second threshold for the liveness parameter is defined by f<n/3, where f is the total number of faulty nodes in the reference shard, the data shard, and each of the plurality of worker shards, and n is the total number of nodes in the reference shard, the data shard, and each of the plurality of worker shards.

Clause 24. The method of Clauses 21-23, wherein the commit message is certified by the first worker shard based on a quorum of x number of signature by the first worker shard, where x>(n+q)/2, n is a total number of nodes in the first worker shard, and q is a total number of nodes needed to establish the quorum for the worker shards.

Clause 25. The method of Clauses 21-24, further comprising: determining, by the reference shard, a status of a second worker shard, of the plurality of worker shards, wherein the status is inactive.

Clause 26. The method of Clause 25, further comprising: decommissioning, by the reference shard, the second worker shard, wherein a second transaction assigned to the second worker shard is reassigned.

Clause 27. The method of Clause 26, further comprising: determining, by the reference shard, the status of a third worker shard, wherein the status is active; and assigning, by the reference shard, the second transaction to the third worker shard.

Clause 28. A method for establishing block consensus in a scalable blockchain network, the method comprising: generating, from a plurality of nodes, through epoch randomness for a first epoch of a plurality of epochs: a plurality of worker shards that meet a first threshold for a safety parameter and a second threshold for a liveness parameter; a reference shard that meets the second threshold for the liveness parameter; and a data shard that meets the second threshold for the liveness parameter; assigning, by the reference shard, a plurality of transactions to the plurality of worker shards for the first epoch of the plurality of epochs; maintaining, by the reference shard, a transaction repository, wherein the transaction repository identifies the plurality of transactions assigned to each of the plurality of worker shards; maintaining, by the data shard, a block repository, wherein the block repository identifies a highest block committed by each of the plurality of worker shards; initiating, by the reference shard, a state transfer from the first epoch to a second epoch of the plurality of epochs; locking, by the reference shard, the data shard from committing new blocks during the state transfer; and reorganizing the plurality of node to generate a plurality of new worker shards based on the first threshold for the safety parameter and the second threshold for the liveness parameter.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A system for scalable block consensus in a blockchain network, the system comprising:
a plurality of nodes, wherein each of the plurality of nodes is a distributed computing device, the plurality of nodes further comprising:
a plurality of worker shards, wherein each worker shard of the plurality of worker shards comprises a first quantity of nodes of the plurality of nodes, and wherein the first quantity of nodes in each of the plurality of worker shards meets a first threshold for a safety parameter and a second threshold for a liveness parameter, and wherein the plurality of worker shards process transaction data corresponding to a plurality of blocks in the blockchain network;
a reference shard, wherein the reference shard comprises a second quantity of nodes of the plurality of nodes, and wherein the second quantity of nodes meets a third threshold for the liveness parameter; and
a data shard, wherein the data shard comprises a third quantity of nodes of the plurality of nodes, and wherein the third quantity of nodes meets a fourth threshold for the safety parameter; and
wherein the system is configured to:
establish a consensus for the transaction data by a first worker shard of the plurality of worker shards, wherein the first worker shard comprises a first set of nodes, and wherein the first worker shard determines the consensus based on a quorum of the first set of nodes;
transmit a commit message to the data shard by the first worker shard, wherein the commit message comprises the consensus for the transaction data;
reorganize the plurality of nodes by the reference shard, based on an epoch interval, wherein the first worker shard is reorganized to comprise a second set of nodes of the plurality of nodes, wherein the second set of nodes is different from the first set of nodes, and wherein the second set of nodes is equal in quantity to the first quantity of nodes; and
broadcast, by the data shard, a highest block number based on the commit message.

2. The system of claim 1, wherein the consensus for the transaction data by the first worker shard is determined by a quorum certificate.

3. The system of claim 2, wherein the quorum certificate requires the quorum of nodes to exceed x number ofsignatures by the first worker shard, where x>(n+q)/2, and wherein n is a total number of nodes in each of the plurality of worker shards, and q is a total number of nodes needed to establish the quorum of nodes in each of the plurality of worker shards.

4. The system of claim 3, wherein q defines the total number of nodes needed to establish the quorum of nodes in each of the plurality of worker shards, wherein f is a total number of faulty nodes in the first worker shard, and wherein q=n−f.

5. The system of claim 1, wherein the liveness parameter determines the number of nodes in each of the plurality of worker shards that are needed to reach the quorum of nodes without the plurality of worker shards stalling indefinitely.

6. The system of claim 1, wherein the commit message comprises a hash value for one of the plurality of blocks.

7. The system of claim 1, wherein the data shard comprises a table corresponding to the highest block number associated with each of the plurality of worker shards.

8. The system of claim 1, wherein the first threshold for the safety parameter of the plurality of worker shards is defined by f<q<n, where f is a total number of faulty nodes in each of the plurality of worker shards, g is the total number of nodes needed to establish the quorum of nodes in each of the plurality of worker shards, and n is the total number of nodes in each of the plurality of worker shards.

9. The system of claim 8, wherein the second threshold for the liveness parameter of the plurality of worker shards is defined by f<n/3, where f is the total number of faulty nodes in each of the plurality of worker shards, and n is the total number of nodes in each of the plurality of worker shards.

10. The system of claim 8, wherein the second threshold for the liveness parameter of the plurality of worker shards is defined by f<n/2, where f is the total number of faulty nodes in each of the plurality of worker shards, and n is the total number of nodes in each of the plurality of worker shards.

11. The system of claim 1, wherein the third threshold for the liveness parameter of the reference shard is defined by f<n/3, where f is a total number of faulty nodes in the reference shard, and n is the total number of nodes in the reference shard.

12. The system of claim 1, wherein the fourth threshold for the liveness parameter of the data shard is defined by f<n/3, where f is a total number of faulty nodes in the data shard, and n is the total number of nodes in the data shard.

13. A method for establishing block consensus in a scalable blockchain network, the method comprising:
generating, from a plurality of nodes, through epoch randomness for a first epoch of a plurality of epochs:
a plurality of worker shards that meet a first threshold for a safety parameter and a second threshold for a liveness parameter;
a reference shard that meets the second threshold for the liveness parameter; and
a data shard that meets the second threshold for the liveness parameter;
assigning, by the reference shard, a plurality of transactions to the plurality of worker shards for the first epoch of the plurality of epochs, wherein a first worker shard of the plurality of worker shards is assigned a first transaction of the plurality of transactions;
maintaining, by the reference shard, a transaction repository, wherein the transaction repository identifies the plurality of transactions assigned to each of the plurality of worker shards;
verifying, by the first worker shard, a commit message associated with the first transaction based on a predetermined number of signatures;
transmitting, by the first worker shard, the commit message to the data shard, wherein the commit message comprises a block number corresponding to the first transaction;
maintaining, by the data shard, a block repositor, wherein the block repository identifies a highest block committed by each of the plurality of worker shards;
verifying, by the data shard, the block number is the highest block committed for the first worker shard; and
broadcasting, by the data shard, an acknowledgement message corresponding to the commit message, wherein the acknowledgement message indicates that the commit message was verified.

14. The method of claim 13, further comprising:
initiating, by the reference shard, a state transfer from the first epoch to a second epoch of the plurality of epochs;
locking, by the reference shard, the data shard from committing new blocks during the state transfer;
reorganizing the plurality of nodes to generate a plurality of new worker shards based on the first threshold for the safety parameter and the second threshold for the liveness parameter; and
performing, by the plurality of new worker shards, a transaction lookup in the transaction repository, wherein the transaction repository indicates a last transaction processed by each of the plurality of new worker shards.

15. The method of claim 13, wherein:
the first threshold for the safety parameter of the plurality of worker shards is defined by f<q<n, where f is a total number of faulty nodes in each of the plurality of worker shards, q is the total number of nodes needed to establish the quorum of nodes in each of the plurality of worker shards, and n is the total number of nodes in each of the plurality of worker shards; and
the second threshold for the liveness parameter is defined by f<n/3, where f is the total number of faulty nodes in the reference shard, the data shard, and each of the plurality of worker shards, and n is the total number of nodes in the reference shard, the data shard, and each of the plurality of worker shards.

16. The method of claim 13, wherein the commit message is certified by the first worker shard based on a quorum of x number of signature by the first worker shard, where x>(n+q)/2, n is a total number of nodes in the first worker shard, and q is a total number of nodes needed to establish the quorum for the worker shards.

17. The method of claim 13, further comprising: determining, by the reference shard, a status of a second worker shard, of the plurality of worker shards, wherein the status is inactive.

18. The method of claim 17, further comprising: decommissioning, by the reference shard, the second worker shard, wherein a second transaction assigned to the second worker shard is reassigned.

19. The method of claim 18, further comprising:
determining, by the reference shard, the status of a third worker shard, wherein the status is active; and
assigning, by the reference shard, the second transaction to the third worker shard.

20. A method for establishing block consensus in a scalable blockchain network, the method comprising:
generating, from a plurality of nodes, through epoch randomness for a first epoch of a plurality of epochs:
a plurality of worker shards that meet a first threshold for a safety parameter and a second threshold for a liveness parameter;
a reference shard that meets the second threshold for the liveness parameter; and
a data shard that meets the second threshold for the liveness parameter;
assigning, by the reference shard, a plurality of transactions to the plurality of worker shards for the first epoch of the plurality of epochs;
maintaining, by the reference shard, a transaction repository, wherein the transaction repository identifies the plurality of transactions assigned to each of the plurality of worker shards;
maintaining, by the data shard, a block repository, wherein the block repository identifies a highest block committed by each of the plurality of worker shards;
initiating, by the reference shard, a state transfer from the first epoch to a second epoch of the plurality of epochs;
locking, by the reference shard, the data shard from committing new blocks during the state transfer; and
reorganizing the plurality of node to generate a plurality of new worker shards based on the first threshold for the safety parameter and the second threshold for the liveness parameter.
